(19) United States
(12) Patent Application Publication
(10) Pub. No.: US 2017/0334062 A1
(43) Pub. Date: Nov. 23, 2017

(54) ROBOTIC DELIVERY UNIT AND SYSTEM

(71) Applicants: Lucas Allen, San Mateo, CA (US); Gregory Jaworski, San Mateo, CA (US); Steven Simoni, San Mateo, CA (US)

(72) Inventors: Lucas Allen, San Mateo, CA (US); Gregory Jaworski, San Mateo, CA (US); Steven Simoni, San Mateo, CA (US)

(21) Appl. No.: 15/599,118

(22) Filed: May 18, 2017

Related U.S. Application Data
(60) Provisional application No. 62/337,880, filed on May 18, 2016.
(60) Provisional application No. 62/458,014, filed on Feb. 13, 2017.

(51) Int. Cl. B25J 5/02; B25J 11/00; B64D 1/08; B23Q 7/14; B25J 5/00; G05D 1/02

(52) U.S. Cl. CPC B25J 5/02; B25J 11/008; G05D 1/0274; B23Q 7/1452; B25J 5/007; G05D 2201/0211; B64D 1/08

(57) ABSTRACT

Aspects of the present disclosure involve an intelligent ordering and delivery system. An internet-based device is used to request delivery of an object or item at a specific location. An internet-of-things robot processes the request and automatically delivers the object or item to the specified location.

### CROSS REFERENCE TO RELATED APPLICATIONS

The present non-provisional utility application claims priority under 35 U.S.C. §119(e) to co-pending provisional application No. 62/337,880 entitled “Internet of Things-Based Robotic Delivery System” filed on May 18, 2016, and which is hereby incorporated by reference herein. The present non-provisional utility application also claims priority under 35 U.S.C. §119(e) to co-pending provisional application No. 62/458,014 entitled “Unmanned Robotic Delivery Unit Between Web Connected Devices” filed on Feb. 13, 2017, and which is hereby incorporated by reference herein.

### TECHNICAL FIELD

Aspects of the present disclosure generally relate to an ordering system and method, and in particular, an ordering system employing a robot for delivering items in restaurants, bars, hotels, and other business establishments located in specific physical areas.

### BACKGROUND

Many businesses, such as bars, restaurants, casinos, hospitals, and/or the like, use humans to deliver goods, products, and services to customers. For example, restaurants and bars frequently prepare and serve beverages such as soft drinks and beer to customers. To provide the soft drinks and/or beer to customers, typically a human server (e.g., a waiter or waitress) will physically prepare and provide (i.e., locate) the food and/or beverages to requesting customers. Alternatively, ordering food and drinks may require customers to go to certain areas, such as a bar, to make an order and receive a good, product, and/or service. In such a scenario, a customer may be relaxing and may not want to get up and physically retrieve his/her order.

Although employing human servers has benefits, there are many issues associated with allowing humans to deliver goods and services to customers. For example, businesses employing human servers must continually account for lost resources, such as time and revenue, due to circumstances directly attributable to human interactions—i.e., poor server attendance, server tardiness, server lack of performance, increased costs (salaries and insurance associated with employing servers), among others. Moreover, many bar and/or restaurants face physical restraints and inefficiencies that directly impact a human server's ability to prepare and deliver products, such as drinks. For example, it is common for popular restaurants, clubs and/or bars to become so crowded that it is difficult for human servers to be able to effectively maneuver throughout the bar and/or restaurant and provide the drinks to customers. Alternatively, crowding often times makes it physically impossible for customers to access a particular area of the restaurant and/or club, such as a bar, where the customer can purchase drinks on his/her own. Thus, both human servers and customers must constantly account for such physical inefficiencies and constraints. In both instances, the lack of access may ultimately lead to more inefficiencies and revenue losses for the restaurant and/or bar owners.

What is needed is an automated and unmanned robotic system capable of automatically taking orders and delivering products (e.g., food and beverages) in a streamlined, efficient, and automated manner to users, such as customers and/or patrons of a bar or restaurant.

### SUMMARY

Aspects of the present disclosure involve apparatuses, systems, and methods for delivering objects to a specific location. The systems and/or apparatuses include a robotic delivery unit configured to deliver an item within a venue, wherein the robotic deliver unit is coupled to a payload for supporting the item. The systems and/or apparatuses include at least one processor communicatively connected to the robotic delivery unit. The systems and/or apparatuses include at least one memory containing instructions that, when executed, cause the computer processor to determine a specific location to which the item should be delivered, based on a request from a client device. The instructions further cause the computer processor to generate a command that instructs the robotic delivery unit to deliver the item to the specific location. The instructions further cause the computer processer to position the robot at a delivery location and thereby carry the item to the delivery location. The instructions further cause the robotic delivery unit to position the payload supporting the item at the specific location, thereby delivering the item.

Aspects of the present disclosure include methods and non-transitory computer readable mediums for delivering objects to a specific location. The methods and/or non-transitory computer readable mediums include based on a request from a client device, determining, using at least one processing device, a specific location for a robotic delivery unit to deliver an item within a venue, wherein the robotic deliver unit is coupled to a payload for supporting the item. The methods and/or non-transitory computer readable mediums include generating, using the at least one processing device, a command that instructs the robotic delivery unit to deliver the item to the specific location. The methods and/or non-transitory computer readable mediums further include wherein the command causes the robot deliver unit to be positioned at a delivery location and thereby carry the item to the delivery location and cause the robotic delivery unit to position the payload supporting the item at the specific location, thereby delivering the item.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 is a system architecture for enabling an ordering system, according to aspects of the present disclosure.

FIG. 2A-2C are schematic system diagrams illustrating an unmanned robotic unit, according to aspects of the present disclosure.

FIG. 3A-3B are diagrams of a payload, according to aspects of the present disclosure.

FIG. 4 is a block diagram of a payload, according to aspects of the present disclosure.

FIG. 5 is another block diagram of a payload and unmanned robotic unit, according to aspects of the present disclosure.

FIG. 6 is a flowchart illustrating an example process for delivering objects and/or items to a specific location in a physical area, according to aspects of the present disclosure.

FIG. 7 is an example of a graphical-user interface for ordering items, according to aspects of the present disclosure.

FIG. 8 is an example of another graphical-user interface for ordering items, according to aspects of the present disclosure, according to aspects of the present disclosure.

FIG. 9 is a block diagram of a computing device specifically configured to generate and process orders, according to aspects of the present disclosure.

### DETAILED DESCRIPTION

Aspects of the present disclosure involve methods and systems that automatically deliver objects and/or items to a specific and precise location included within certain physical area. In various aspects, a network-connected robotic device and related computing components may be implemented at or within a specific physical area or facility, such as at a restaurant or bar or other type of retail establishment. The network-connected robotic device may be used to automatically deliver objects to specific and precise locations included within the physical area or facility.

In other aspects, users, such as customers interested in ordering objects and/or items within the physical area of a restaurant or bar, may interact with a network-enabled client device to directly order products using an electronic version of the restaurant or bar's menu. The generated order may be transmitted to a server computing device for processing, thereby eliminating the need for human servers to take orders and provide ordered products, goods, and/or services to users. An order may include a unique identifier, the identification of one or more objects/items to be delivered, a delivery time, customized options selected by the user for delivering the item (i.e., order details for the item/and or object), payment information and details, and/or the like.

The various concepts of the present application are described in the context of a restaurant or bar, particularly within the context of processing orders for food and/or drinks within a restaurant or bar. It is contemplated, however, that the various concepts described herein may be more generally applied to other industries and contexts, such as for example, in any industry where order processing and fulfillment of tangible items occurs.

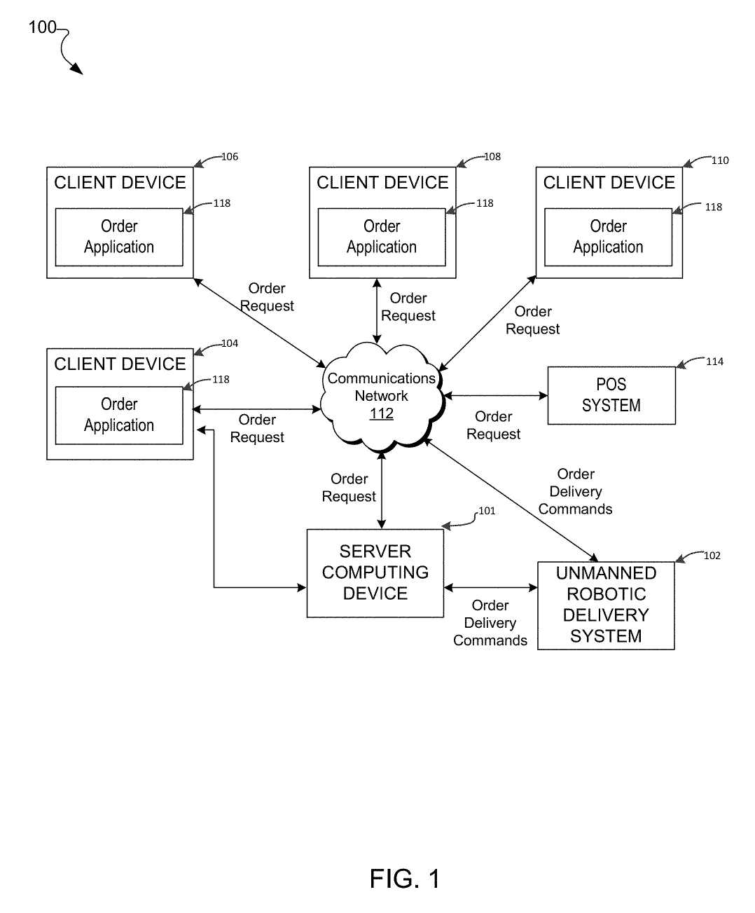

FIG. 1 is a system diagram of one possible implementation of a robotic delivery system computing environment 100 capable of automatically processing object orders and delivering one or more objects, such as beverages and drinks, to users at requesting locations in a certain physical area such as a restaurant, bar, coffee shop, or other retail business. As illustrated, the system 100 includes a server computing device 101 that receives and processes requests and/or orders (or related transactions) for various objects or items, such as beverages and drinks. More specifically, the computer server device 101 may include or otherwise integrate one or more processors, processing units, and/or processing devices capable of automatically processing orders and generating commands and/or otherwise executing instructions that cause various components of a unmanned robotic delivery system unit (“URDS”) 102 to automatically retrieve and deliver (e.g., optionally dispense) the ordered objects and/or items to users. Thus, based on the processed orders, the computer server device 101 generates commands and/or instructions that control the functions of the URDS 102 to deliver products and/or services to users.

The orders and/or requests for various objects (e.g., beverages and/or drinks) may be received from one or more client devices 104-110 distributed throughout and/or otherwise accessible (i.e., networked) via a communications network 112 (e.g., a cloud computing arrangement), which may be an IP-based telecommunications network, the Internet, an intranet, a local area network, a wireless local network, a content distribution network, or any other type of communications network, as well as combinations of networks. The one or more client devices 104-110 may be a personal computer, work station, mobile device, mobile phone, tablet device, processor, and/or other processing device capable of implementing and/or executing processes, software, applications, etc., that includes Bluetooth, Wi-Fi, network-enabled devices and/or software, such as order application 118 configured to communicate over the communications network 112 (e.g., via an internet browser), which may be the Internet, an intranet, an Ethernet network, a wireline network, a wireless network, and/or another communication network. The one or more client device(s) 104-110 may further include one or more processors that process software or other machine-readable instructions and may include a memory to store the software or other machine-readable instructions and data. In one specific embodiment, the order application 118 may generate an electronic menu to enable a user to generate an order at the client devices 104-110. The ordering application may be a pre-downloaded application on the client device, or it may simply be a dynamically generated (e.g., in real-time) web site. In yet other embodiments, the one or more client devices 104-110 may be a switch or button fixed in place at the delivery location, used to order one specific item (e.g., a bucket of beers).

Thus, a user may interact with the one or more client devices (e.g., a smart phone) 104-110 to generate an order for an item. For example, in the context of a restaurant, where a waiter may typically humanly interact with a customer to enable the customer to order a beverage or drink, the customer may instead interact with the one or more client devices 104-110 and generate a request/order for drinks and/or food. As another example, using any of the client devices described above, a user may be able to generate an order using a touch screen and/or buttons, etc., to input an order. In some embodiments, the order includes only submitting an order request, and in other embodiments, the order includes submitting the order request and paying for the purchase. Thus, the server computing device 101 may be integrated with or otherwise implement various payment processing functions, platforms (e.g., Stripe) and/or the like, capable of processing payments.

The request and/or order may be automatically transmitted from the one or more client devices 104-110 to the server computing device 101 for processing, resulting in the URDS 102 automatically delivering and/or dispensing the item, such as drink or food, to the requesting location of the applicable one or more client devices 104-110. In particular, the server computing device 101 processes the order to generate a series of commands, which when transmitted to the URDS 102 cause the URDS 102 to deliver items and/or objects, such as beverages, to the specific location of the requesting client device. In one embodiment, delivering the item involves raising/lowering a payload carrying the item to a height accessible by a user, as will be described in greater detail below. In other embodiments, delivering the item involves the URDS 102 actually dispensing the item from the payload, as will be described in further detail below. Thus, if a user were to generate an order by interacting with the client device 104, the URDS 102 may deliver the ordered item to the location of the client device 104 within the physical area. In another embodiment, the URDS may deliver the ordered item to a location specified by the client device. Thus, a user can interact with the one or more client devices 104-110 to order items, such as drinks and/or food, and engage in various other transactions, such as pay his/her bill as when he/she chooses, all without the need to attract the attention of a waiter or any other human intervention.

The server computing system 101 and the one or more client devices 104-110 may functionally connect with or otherwise communicate with a point of sales system (“POS”) 114 that provides at least one centralized server that implements functionality to process orders received from the one or more client devices 104-110. The POS 114 may implement various point-of-sale functionalities, such as point-of-sale printers, payment card readers (not shown), etc. In one specific example, the POS 114 may include a cloud computing server that maintains a database of customer orders, and a tablet device located at a designated station (e.g., bartender station) which connects (via the internet) to the cloud computing server 101 in order to, for example: 1) download a list of outstanding drink orders; 2) upload refund commands for out-of-stock items; and 3) upload delivery commands to be forwarded to the robot.

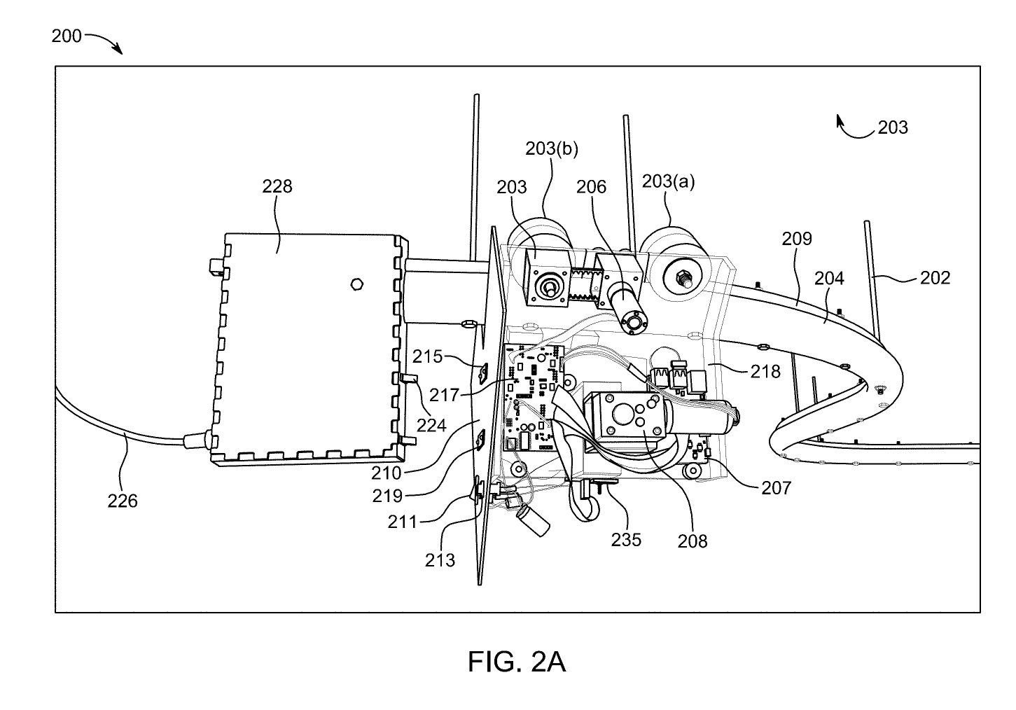

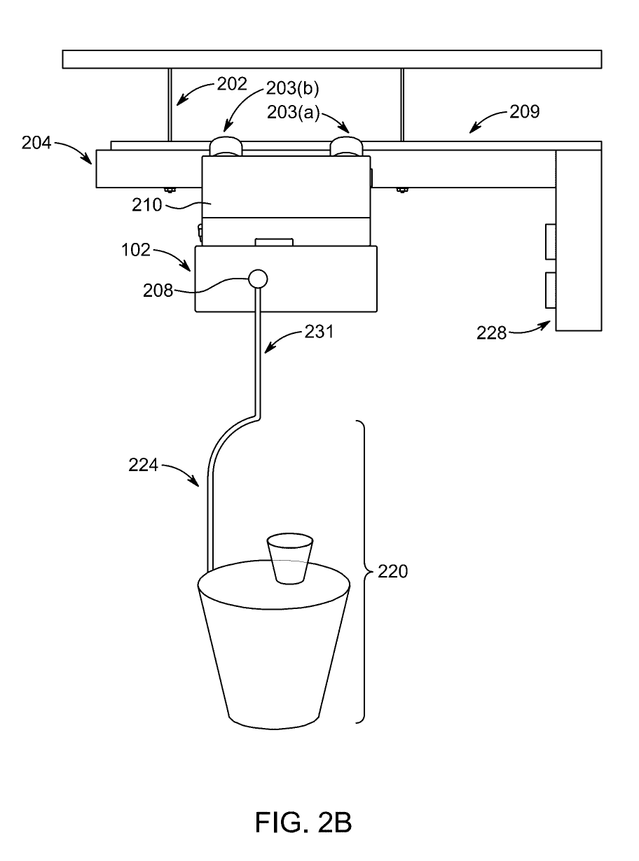

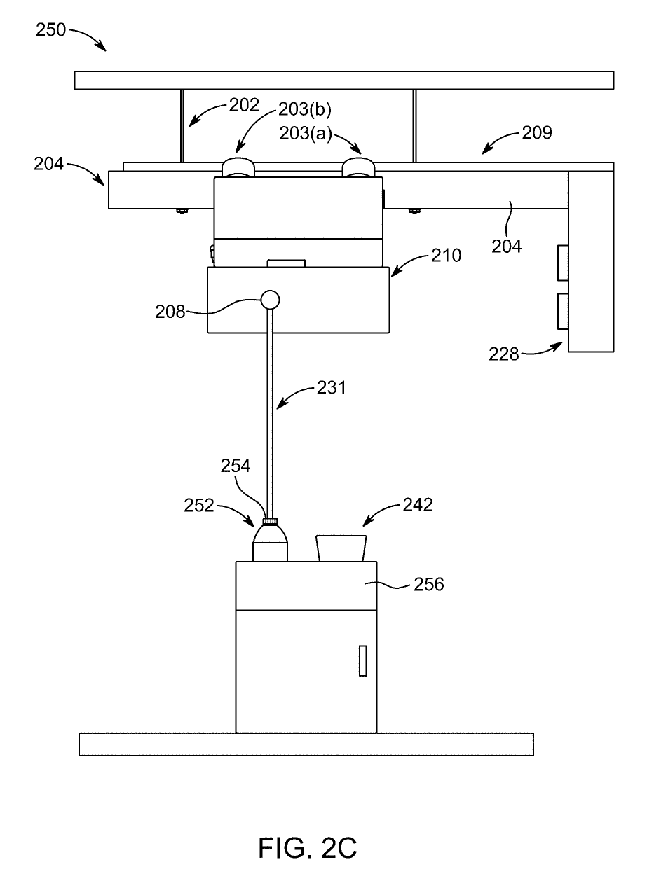

FIGS. 2A-2C are system diagrams 200, 250, and 260 of the UDRS 102, according to aspects of the present disclosure. In the illustrated embodiments, the URDS 102 is depicted as a robotic serving unit capable of delivering and/or dispensing beverages within a certain physical area of a restaurant, bar, coffee shop, and related retail businesses. Referring initially to FIG. 2A, a suspendable structure referred to as a track 204 is mounted at an elevated level to a building structure of a physical location, such as to the ceiling and/or wall of a physical location (illustrated at 202). Thus, the track 204 may be oriented to follow various wall and/or ceiling surfaces while traversing an area of the physical location. For example, in the context of a bar or restaurant, the track 204 may be mounted to the ceiling and traverse across and/or through various areas of the restaurant and/or bar area where customers may access beverages and drinks. In particular, the restaurant may include individual seat locations and/or table locations that represent target delivery locations. Thus, the track 204 enables the URDS 102 to be positioned along the track 204 at a certain delivery location and thereby deliver objects to the specific location or a requesting user and/or the target delivery locations (e.g., individual seats or tables) determined based on the specific location.

The track 204 may be cylindrical in shape, e.g., shaped like a pipe, curved at various points along its length, and further, may be sufficiently rigid and strong so as to support the weight of the URDS 102 and its contents. For example, the track 204 may be an ABS pipe, PVC pipe, steel pipe, curtain rod, among others. In other embodiments, the track 204 may be rectangular and shaped similar to various steel structures, such as a WT or ST structural tee shape, wide-flange shape, American standard shape, L-angle shape, bar shape, plate shape, t-shape, and/or the like.

The track 204 may be mounted using a variety of mechanisms, such as a variety of clamps and brackets, such as U-shaped brackets and fasteners generally known for securing pipe segments along a wall or wall studs. Likewise straps and the like are known for suspending piping from a ceiling or ceiling joints. Alternatively, other mounting hardware may be used to couple the track 204 to the ceiling, such as threaded rod and/or simple threaded rod hanger. In any embodiment, the mounting hardware is positioned in a manner not to interfere with wheels as the URDS 102 travels along the track 204.

In one specific embodiment, the URDS 102 includes a Y-shaped inner frame 218 and outer housing 210 (shown partially removed). Functionally coupled to the outer housing 210 is a battery disconnect switch 211, a soft power switch 213, and one or more charging contacts 215 and 219. The housing 210 encloses or otherwise includes an electric drive motor 206 that rotates in response to applied voltage, and is fitted with a magnetic rotary encoder, which outputs a square wave as the motor rotates. By counting transitions of the square wave, motor speed and position may be measured. The electric drive motor 206 serves to drive a series of wheels 203(a) and 203(b) along the track 204 to a specific location. The Y-shape of the inner frame 218 allows the set of drive wheels 203(a) and 203(b) to make solid contact with the track 204, enabling motion.

The electric drive motor 206 receives power, communication, and motor-control from a motor controller circuit 217, which in turn receives communication from a processing unit 207, such as a single-board processing unit. The processing unit 207 sends motor commands to motor controller circuit 217, receives motor encoder counts from motor controller circuit 217, estimates robot position, and processes networked communications between the USDS 102 and the server computing device 101. In one specific example, power is transmitted from a motor shaft to a pulley, through a timing belt, to another pulley attached to the drive wheels. In some embodiments, a second electric drive motor 206 may be included in the opposite side of the frame 218, which drives a second set of drive-wheels on the opposite side of the robot.

In some embodiments, the frame 218 may include and/or otherwise be coupled to a circuit 235 containing one or more Red/Green/Blue LED lights and one or more audio speakers for providing feedback from the USDS 102 to users. Additionally, in some embodiments, the frame 218 may include and/or otherwise be coupled to downward-facing camera 240 (not shown), such as a Raspberry Pi Camera. In one specific example, the housing 210 may include an opening (not shown) through which the camera 240 protrudes.

The motor controller circuit 217 contains the motor driver transistors, motor encoder interface, over-current protection, and other monitoring circuits. The motor controller circuit 217 acts as the interface between processing unit 207 and the motors. In particular, the motor controller circuit 217 monitors the motor encoders to maintain a count of motor encoder pulses, and it monitors system voltages and currents, including total battery current, battery voltage, and charger input voltage. The motor controller circuit 217 sends these parameters to the processing unit 207, for example via an RS-232 serial link. The motor controller circuit 217 receives motor speed setpoints and the power-off command from the processing unit 207, via the serial link. The motor controller circuit 217 responds to the power-off command by turning off a P-MOSFET transistor located between the battery positive terminal and the circuit power bus. The motor controller circuit 217 responds to motor speed setpoints by adjusting motor current to maintain the specified motor speed. Motor current is adjusted via pulse-width modulation (PWM) of the drive transistors, and motor speed is measured, for example, by counting encoder pulses in an 8 ms time period.

A drive wheel mount 203 and the set of wheels 203(a) and 203(b) may be coupled to the track 204 and the frame 218 to effectively secure the frame 218 to the track 204 and enable the URDS 102 to travel along the length of the track 204. In one specific example, the set of wheels 203(a) and 203(b) may include four wheels, two coupled to each side of the track 204 at 45 degree angles. A guide element 209 may be coupled along the top of the track 204 to serve as a guide that prevents the URDS 102 from excessively tilting. For example, if the URDS 102 tilts in an excessive manner to the left, the right wheel(s) may contact the guide element 209, which prevents further tilt. In the illustrated embodiment, the guide element 209 is a rectangular aluminum tube affixed along the top of the track, although other arrangements are contemplated.

Referring now to FIG. 2B, a cable or winchline 231 (e.g., a steel wire, fishing line, etc.) may be functionally coupled to the URDS 102 to raise and/or lower a payload 220, depending on the voltages received from a motor controller circuit 208 which are determined based on motor speed commands received from processing unit 207 which are ultimately based on delivery commands received from the server processing device 101. The winchline 231 is coupled to a worm-gear motor 208 to enable the raising and/or lowering of the payload 220. A worm-gear motor 208 is used because it resists motion in the unpowered state, ensuring that the payload 220 does not lower in the event that power to the worm-gear motor 208 is removed or otherwise lost. In one specific embodiment, a shaft of the worm-gear motor 208 is attached to a spool. Coupled to the spool is the winchline 231. A carabiner (not shown) may be attached to the end of the winchline 231, to allow easy changes of the payload 220.

The payload 220 is configured as a carrying mechanism, such as a basket, capable of supporting items being delivered within the physical area, such as drinks and/or food. The payload 220 functions to deliver or optionally dispense the supported items to a specific delivery location within the physical area. For example, the URDS 102 may travel along the track 204, above head height (of patrons in the physical area such as a restaurant) and then lowers the payload 220 to the delivery location that is within human reach (and generally below head height).

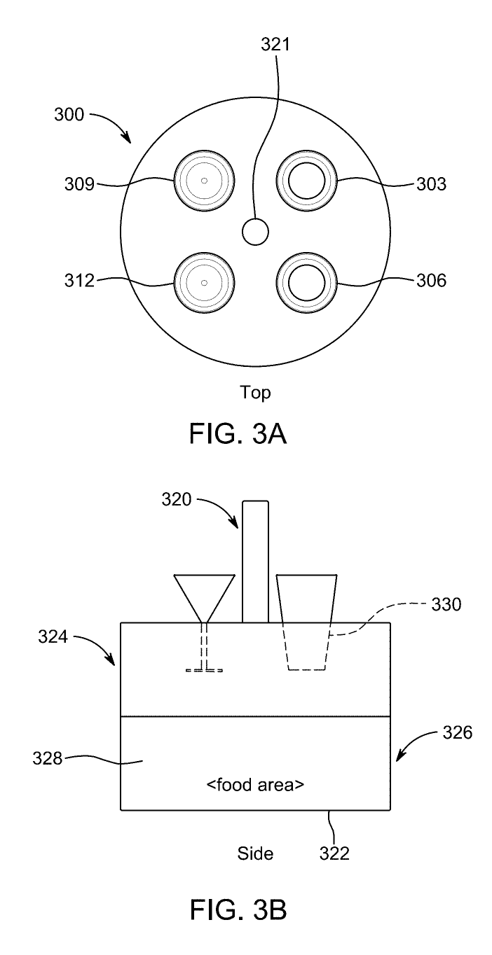

FIG. 3A-3B provides an illustration of a top view 300 and side view 320 of the payload 220, according to one embodiment. Referring initially to the side view 320, the payload 220 is depicted as a rectangular or box-shaped carrying mechanism, such as a bucket, and includes a bottom wall 322, a pair of upstanding sidewalls 324 and 326 and end walls 328, each of which is sized for and configured in accordance with requirements to accommodate different types and sizes of items, such as different sizes of food and beverage items/containers.

Referring to the top view 300, a central element 321 indicates where a rigid element may be coupled to payload 220. One or more beverage container-supporting holes, dents, cuts, 303, 306, 309, and 312 may extend through the housing for supporting beverage or drink containers as shown in the side view 320 at phantom lines 330. In some embodiments, inserts may be coupled to the one or more beverage container-supporting holes 303, 306, 309, and 312 to accommodate smaller or oddly-shaped containers.

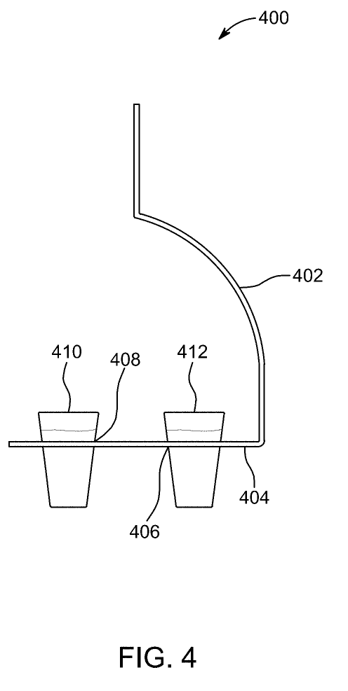

FIG. 4 depicts another, different, design 400 of the of the payload 220, according to one embodiment. As illustrated, the carrying apparatus consists of rigid body 402, including a base 404. One or more beverage container-supporting holes, dents, cuts, 406-408 may be cut through the base for supporting beverage or drink containers as shown at 410 and 412.

Referring again to FIGS. 2A and 2B, in one specific example, the USDS 102 will automatically stop raising/lowering the payload 220 based on pulse counts received from the encoder of worm gear motor 208. Alternatively, in some embodiments, the winchline 231 may be coupled to the payload 220 using a device which activates a physical or magnetic limit switch. In such an embodiment, the limit switch may be activated when the payload 220 raises sufficiently far. Other methods of sensing the height of payload 220 may also be used, such as ultrasonic or infrared distance sensors, cameras, or an absolute rotary encoder coupled to the winch shaft.

A rigid body 224 is operatively coupled to the winchline 231 and the payload 220. The rigid body 224 prevents the payload 220 from tilting excessively. In the illustrated embodiment, the pivot point of the right body 224 is placed above the center of mass of the payload 220 to ensure that off-center loads do not cause excessive tilting. A charging station 228 is coupled to the track 204 to enable the USDS 102 to dock. In particular, the charging station 228 creates electrical contact that thereby recharges the batteries of the USDS 102. In other embodiments, the USDS 102 may receive power in other ways, such as through the track 204. In yet other embodiments, the charging station 228 may be configured such that the robot can drive through it.

Referring now to FIG. 2C, one or more beverages or beverage containers 252 may be retrieved for delivery. In the illustrated embodiment, the USDS 102 employs a grasping mechanism 254 to grab or otherwise securely grip one of the one or more beverage or beverage containers and carry the beverage and/or beverage container to a destination. For example, in one embodiment, the USDS 102 may use a magnetic grasping device to retrieve an object, wherein a magnet is pre-attached to each item to be retrieved. In such an embodiment, a magnet would be coupled to each of the one or more beverage or beverage containers 252. The object may be retrieved from an object-dispensing system 256, such as a ramp (as in a grocery store), a spring or feed-screw (as in vending machines), a gravity-fed mechanism (as in a soda machine), among others. In such an embodiment, the customer would manually detach the magnet and beverage from the robot at the delivery destination.

The URDS 102 may engage in various verifications and/or diagnostic checks and transmit messages to the server computing device 102 about its status and usage patterns, statistics, etc. For example, the URDS 102 may automatically check to make sure all sensors are working, check the disk space on the onboard computers, and/or check the battery voltage and current. If one or more of these checks failed, the URDS 102 may transmit a notification to the server computing device 101 that the URDS 102 cannot go on a delivery. To facilitate additional features and communications, the URDS 102 and the server processing device 101 may be in continuous and constant communication while the URDS 102 is delivering an item to a specific location. In one embodiment, the URDS 102 may include a forward-looking sensor, such as an infrared distance sensor, to check for obstacles in its path. In such an embodiment, it transmits a notification to the server computing device 101 indicating that the URDS 102 cannot deliver am item if/when the forward-looking sensor is obstructed, thereby indicating that the path of the URDS 102 is obstructed.

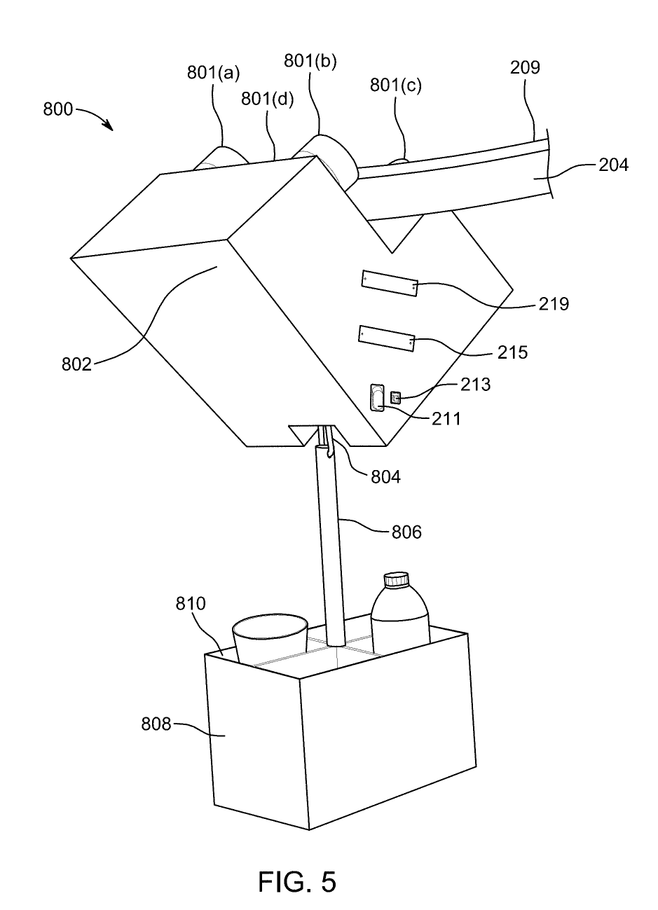

FIG. 5 is another example schematic illustration 800 of a URDS and associated housing 802 (e.g., similar to the URDS 102 and housing 210) and a payload 808 (e.g., similar to payload 220). In the illustrated view, the housing of the URDS 802 includes a power switch 211, a soft battery disconnect switch 213, and one or more charging contacts 215 and 219. The URDS 802 is coupled to a set of wheels 801(a), 801(b), 801(c), and 801(d) which are functionally coupled to a track 204. A carabiner 804 connects the winchline (obscured by the robot housing in this illustration) to a payload 806-810 including one or more sections for carrying beverages to specific locations.

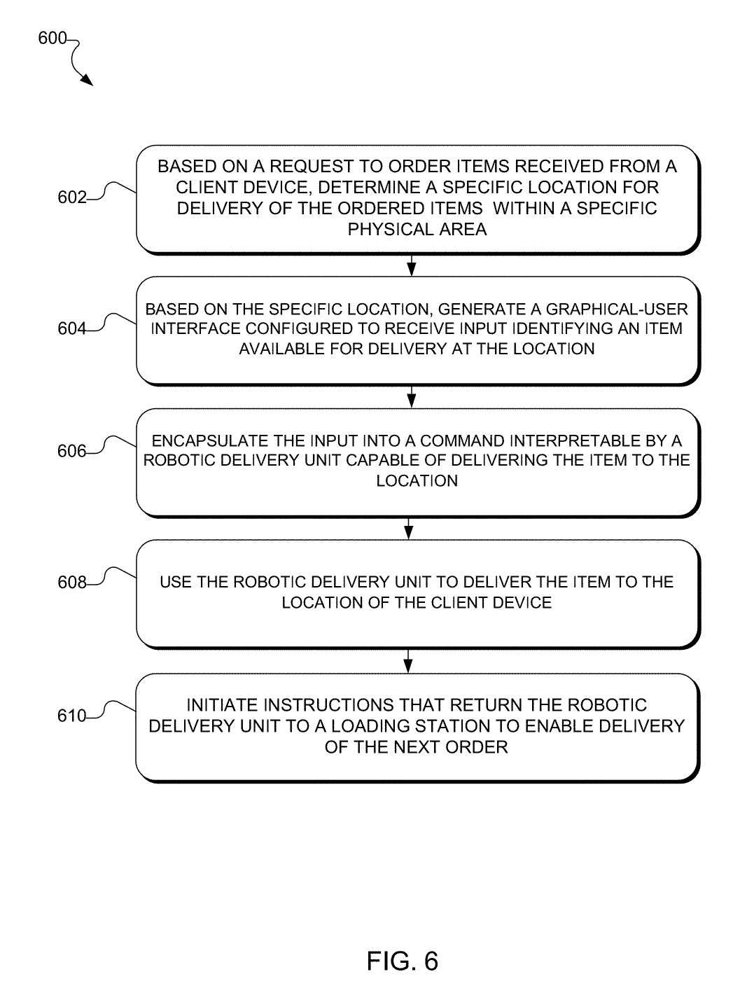

An illustrative process for automatically providing objects to users in a physical area or facility, such as a restaurant, bar, coffee shop, and/or other retail business is depicted in FIG. 6 and will be explained with reference to FIGS. 1 and 2A-2C. In particular, FIG. 6 illustrates an example process 600 for automatically providing objects, such as beverages to users. As illustrated, process 600 begins with determining a specific location for delivering an item within a physical area, based on a user client device that is requesting to order (or already ordered) items and/or objects within the specific physical area, such as a beverage or drink at a restaurant or bar (operation 602). Referring to FIG. 1, a user (e.g., a customer) may interact with one or more of the client devices 104-110 to initiate the ordering of a drink at a specific location within the restaurant or bar. At initial interaction (i.e., when the user indicates he/she would like to place an order), the location of the specific client device (e.g., a particular client device of the one or more client devices 104-110) used to initiate the order may be precisely determined to identify the specific location. Alternatively, data captured at the client device may be used to determine the specific location for delivery.

For example, in one specific embodiment, the location may be determined based on an alphanumeric keyword, barcode, iQR code and/or QR code that embeds and/or otherwise identifies location information identifying the location within the physical area or the location of the client device located within the physical area. In another embodiment, a database included in the server computing device 101 is used to map an alphanumeric keyword, such as “Fox”, to a specific distance along the track 204 and/or a specific height of the payload 220 (generally referred to as a robot position delivery location) that enables the URDS 102 to deliver the item to the specific location determined based on the requesting client device. Thus, the server computing device 101 maintains a data structure containing entries that map alphanumeric keywords to various delivery locations interpretable by the URDS 102. In such an embodiment, the one or more client devices 104-110 may include a capturing component, such as an application that prompts for an alphanumeric keyword, a camera or a scanner for scanning, reading, and/or capturing the barcodes, a decoder for decoding the captured iQR or QR codes, etc., and/or one or more software applications (e.g., client-side software) for processing such codes.

In other embodiments, the specific location may be determined by a GPS or other location identifying system embedded within the one or more client devices 104-110. In yet another embodiment, the client device may be fixed in place at the specific location. In yet another embodiment, the client device may receive a location code from another client device through social media or a web link. In yet other embodiments, the specific location may be determined based on a near field communication (NFC) reader, by inferring a location based on how the client device 104-110 connected to the network, or any other mobile device localization method.

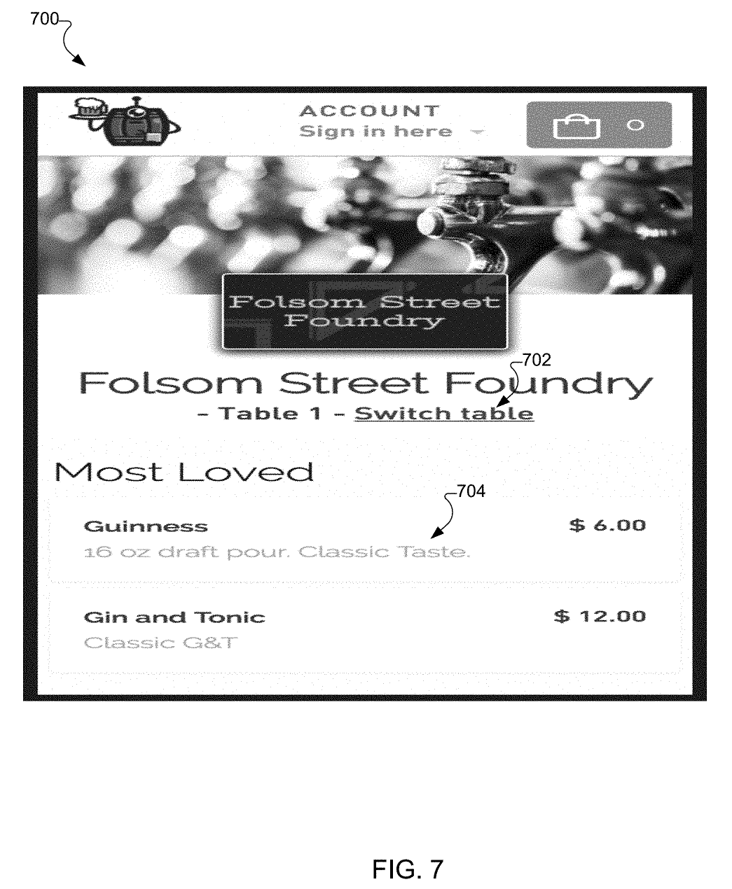

Referring again to FIG. 6, based on the determined specific location, one or more graphical-user interfaces may be generated or otherwise provided to the client device used to initiate the order (operation 604). Referring to FIG. 1, a user may interact with the graphical user-interfaces to provide input identifying a specific order of items available for order and delivery at the identified location. In one embodiment, the graphical-user interfaces may be a menu or other listing of the various items and/or objects available for ordering at the identified location. For example, in the context of a restaurant, the graphical-user interfaces may correspond to the menu of the restaurant that describes the various food and beverages that may be ordered by customers dining at the restaurant. FIG. 7 provides an illustration of a graphical-user interface 700 that may be generated at the one or more client devices 104-110 to enable the user to initiate an order of a drink. A user interacts with the various forms and components 702 and 704 of the graphical user-interface 700 to generate an order containing an item for delivery by the URDS 102. In some embodiments, the various generated graphical user-interfaces may enable a user to automatically initiate a payment process that enables the user to pay for the ordered items.

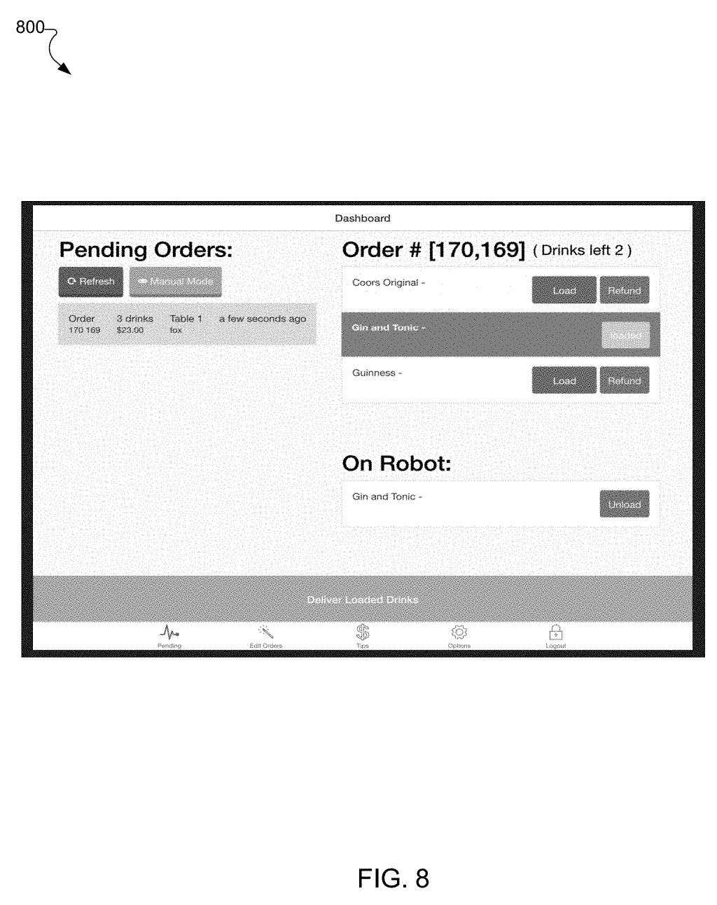

In some embodiments, the input received at the graphical-user interfaces may be encapsulated into an order request containing the requested items and the determined specific location. Referring to FIG. 1, in one embodiment the requested items are loaded by the human bartender who views the requested items using POS system 114. In such an embodiment, the transmitted order request may be displayed in a graphical user-interface at the order POS 114 that illustrates or otherwise identifies the items included in the order that may be delivered by the URDS 102. Subsequently, a user (e.g., bartenders or waiters/waitresses) may interact with the displayed interface to initiate the processing of the order—i.e., indicate that the URDS 102 is loaded and ready for delivery and thereby generate a delivery command. (In other embodiments the robot will load itself from a dispenser as part of delivery, as discussed previously). FIG. 8 provides an illustration of a graphical-user interface 800 that may be generated at the order POS 114 to enable the user to initiate processing of a drink order.

Referring again to FIG. 6, the order request or the delivery command is encapsulated into a command or instructions interpretable by the URDS and transmitted from the server computing device to the URDS, which automatically causes the URDS to begin delivery of the object to the specific location (operation 606). In one embodiment, the delivery command includes a specific sequence of motor speeds that will cause the robot to arrive at the specific location. In other embodiments, the delivery command includes only the delivery location coordinates (expressed as distance to drive along the track, and distance to lower the basket), and the URDS 102 uses an internal control system to determine motor speeds and reach the specific location. In yet other embodiments, a combination of pre-planned speeds and an internal control system is used. In one embodiment, all the above transmissions are expressed in the JavaScript Object Notation (JSON) text format, and transmitted via the HTTPS protocol through the communications network 112.

Referring again to FIG. 6, in response to the command, the URDS traverses the track to reach the delivery location (operation 608). In one specific embodiment, an algorithm may be implemented to control the movement and function of the URDS 102 and/or the various components of the URDS 102 including the payload 220 when delivering an ordered item to a specific location. In particular, the algorithm uses the motions of the URDS 102 to control both 1) the swinging of the payload 220 and 2) the position of the URDS 102. The algorithm consists of two parts:

Part (1) Physics Simulation: the “inner loop” of the algorithm is a physics simulation. It models the payload as a simple pendulum in order to simulate the payload's response to URDS acceleration. Inputs to the simulation are: 1) the initial positions and velocities of the robot-pendulum system (e.g., the URDS and the payload; 2) the length of the pendulum (i.e. meters from the pivot point to the center of mass); and 3) a robot (e.g., the URDS 102) acceleration sequence along 1, 2, or 3 dimensions. (A robot acceleration sequence is a specific acceleration of the robot at each point in time. For example, one such sequence is “apply +1 m/ŝ2 of acceleration from t=0 to t=2 seconds, 0 m/ŝ2 from t=2 to t=10, and −1 m/ŝs from t=10 to t=12. End simulation.”)

The x-axis acceleration of the payload relative to the robot is:

where g is the gravitational constant 9.8 m/ŝ2 and θ is the payload deviation from vertical in radians, in the +x direction. The equivalent calculation is performed to find y-axis acceleration of the payload. If z-axis robot acceleration is being simulated, the z-axis robot acceleration is simply added to g in the above formulas.

The algorithm numerically integrates payload acceleration with respect to time to find the payload velocity at each point in time. It integrates payload velocity to find the payload position (and, therefore, swing angle) at each point in time. In the same way, the algorithm integrates robot acceleration to find robot velocity and position. Thus, the physics simulation outputs the sequence of robot and payload positions that will be produced by a given acceleration sequence.

Part (2): Optimizer: the “outer loop” of the algorithm is an optimizer algorithm. Inputs to the optimizer include constraints, such as the initial and final positions of the robot, maximum payload swing angle, and maximum robot speed. Inputs also include an “objective function” to be minimized or maximized. (The typical objective is to minimize the total time required for the robot to reach its destination.) The optimizer searches for the optimal acceleration sequence, using the physics simulation “inner loop” to evaluate possible acceleration sequences. The optimizer outputs the best acceleration sequence it could find, or indicates failure if no feasible acceleration sequence was found.

(Usage as part of the payload delivery system). The algorithm may be run in real time, thus planning the next few seconds of robot acceleration to limit payload swinging while bringing the robot closer to a high-level goal (such as the final desired position). In that usage, the initial state of the physics simulation comes from sensors on the robot (such as motor encoders or a downward-facing camera).

Alternatively, the algorithm may be run before the robot moves, thus planning and caching a sequence of accelerations that will accomplish an entire robot delivery mission. In that usage, the initial state of the physics simulation comes from an assumed rest state of the robot. Combinations of the two may also be used, such as a pre-cached overall acceleration sequence, but with real-time planning of small deviations in response to sensor inputs.

Referring again to FIG. 6, the URDS 200 is returned (i.e., traverses the track 204 in reverse) to its original loading station position to enable loading of the next delivery (operation 610). Once at the delivery location, the URDS 102 uses one of the following means to determine when the delivery is complete: 1. A load cell, or equivalent sensor (such as measuring the voltage required to slightly raise the payload), is used to detect that items have been removed. 2. The user indicates (via the client device) that items have been removed. 3. A timeout is configured on the robot to return home after a set time. 4. The person at the loading station commands the robot to return via the loading station user interface. 5) A camera detects that items are absent from the basket. Once the item has been delivered, the robot to returns to its original location (e.g., loading station) to prepare for delivery of the next item (operation 610).

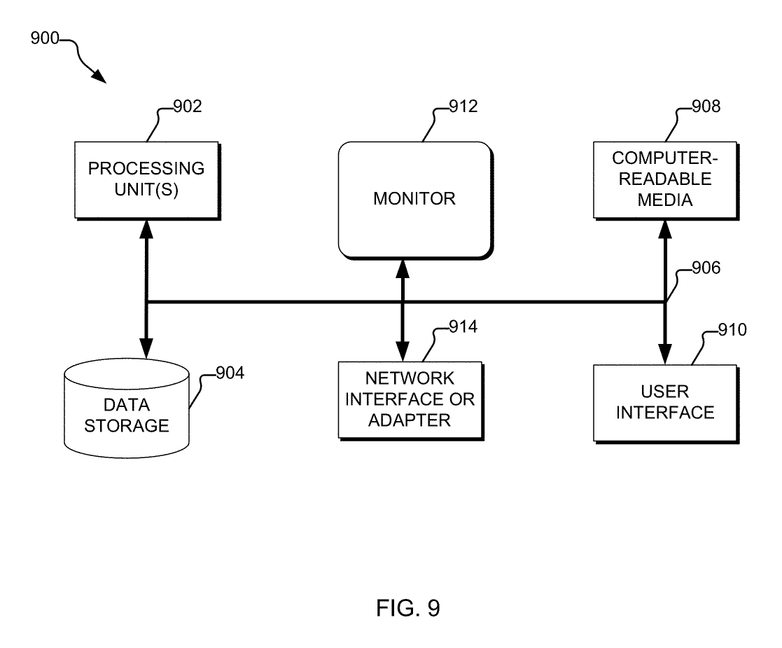

FIG. 9 illustrates an example of a suitable computing and networking environment 900 that may be specifically designed and configured to implement various aspects of the present disclosure described in FIGS. 1-2A-2C, such as the USDS 102. As illustrated, the computing and networking environment 900 includes a general purpose computing device 900, although it is contemplated that the networking environment 900 may include one or more other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computer 900 may include various hardware components, such as a processing unit 902, a data storage 904 (e.g., a system memory), and a system bus 906 that couples various system components of the computer 900 to the processing unit 902. The system bus 906 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 900 may further include a variety of computer-readable media 908 that includes removable/non-removable media and volatile/nonvolatile media, but excludes transitory propagated signals. Computer-readable media 908 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computer 900. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The data storage or system memory 904 includes computer storage media in the form of volatile/nonvolatile memory such as read only memory (ROM) and random access memory (RAM). A basic input/output system (BIOS), containing the basic routines that help to transfer information between elements within the computer 900 (e.g., during start-up) is typically stored in ROM. RAM typically contains data and/or program modules that are immediately accessible to and/or presently being operated on by processing unit 902. For example, in one embodiment, data storage 904 holds an operating system, application programs, and other program modules and program data.

Data storage 904 may also include other removable/non-removable, volatile/nonvolatile computer storage media. For example, data storage 904 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 9, provide storage of computer-readable instructions, data structures, program modules and other data for the computer 900.

A user may enter commands and information through a user interface 910 or other input devices such as a tablet, electronic digitizer, a microphone, keyboard, and/or pointing device, commonly referred to as mouse, trackball, or touch pad. Other input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 902 through a user interface 910 that is coupled to the system bus 906, but may be connected by other interface and bus structures, such as a parallel port, game port or a universal serial bus (USB). A monitor 912 or other type of display device is also connected to the system bus 906 via an interface, such as a video interface. The monitor 912 may also be integrated with a touch-screen panel or the like.

The computer 900 may operate in a networked or cloud-computing environment using logical connections of a network interface or adapter 914 to one or more remote devices, such as a remote computer. The remote computer may be a personal computer, a server, a router, a network PC, a peer device or other common network node, and typically includes many or all of the elements described above relative to the computer 900. The logical connections depicted in FIG. 9 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 900 may be connected to a public and/or private network through the network interface or adapter 914. In such embodiments, a modem or other means for establishing communications over the network is connected to the system bus 906 via the network interface or adapter 914 or other appropriate mechanism. A wireless networking component including an interface and antenna may be coupled through a suitable device such as an access point or peer computer to a network. In a networked environment, program modules depicted relative to the computer 900, or portions thereof, may be stored in the remote memory storage device.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A system for delivering objects to a specific location comprising:
a robotic delivery unit configured to deliver an item to a specific location within a venue, the robotic deliver unit coupled to a payload for supporting the item;
at least one processor communicatively connected to the robotic delivery unit; and
at least one memory containing instructions that, when executed, cause the computer processor to:
based on an order request received from a client device, determine the specific location to which the item should be delivered;
generate a command that instructs the robotic delivery unit to deliver the item to the specific location; and
transmit the command to the robotic delivery unit to:
cause the robotic delivery unit to be positioned at a delivery location and thereby carry the item to the delivery location; and
cause the robotic delivery unit to position the payload supporting the item at the specific location, thereby delivering the item.

2. The system of claim 1, wherein the at least one processor is further configured to:
generate and display a graphical-user interface corresponding to the venue, wherein the graphical user-interface includes user selectable components for selecting items available for delivery within the venue; and
receive a user-selection on the graphical user interface that identifies the item, wherein the item is delivered by the robotic unit according to delivery details associated with the user-selection.

3. The system of claim 1, wherein the robot travels along a track contained within the venue and the delivery location consists of a specific position along the track.

4. The system of claim 1, wherein the specific location is determined based on at least one of a quick response (QR) code, an alphanumeric code, GPS, WiFi triangulation, a proximity to a NFC transmitter, and a barcode.

5. The system of claim 1, wherein the venue is a restaurant having individual seat locations as target delivery locations, and wherein the at least one processor is further configured to:
identify at least one individual seat as a target delivery location based on the specific location.

6. The system of claim 1, wherein the venue is a restaurant having table locations as target delivery locations, and wherein the at least one processor is further configured to:
identify at least one table as a target delivery location based on the specific location.

7. The system of claim 1, wherein a path followed by the robotic delivery unit to the delivery location is over the head of the user at the specific location.

8. A method for delivering objects to a specific location comprising:
based on a request from a client device, determining, using at least one processing device, a specific location for a robotic delivery unit to deliver an item within a venue, the robotic deliver unit coupled to a payload for supporting the item;
generate, using the at least one processing device, a command that instructs the robotic delivery unit to deliver the item to the specific location; and
transmitting the command to the robotic delivery unit to cause the robot delivery unit to:
be positioned at a delivery location and thereby carry the item to the delivery location; and
position the payload supporting the item at the specific location, thereby delivering the item.

9. The method of claim 8, further comprising:
generating and displaying a graphical-user interface corresponding to the venue, wherein the graphical user-interface includes user selectable components for selecting items available for delivery within the venue; and
receiving a user-selection on the graphical user interface that identifies the item, wherein the item is delivered by the robotic unit according to delivery details associated with the user-selection.

10. The method of claim 8, wherein the robot travels along a track contained within the venue and the delivery location consists of a specific position along the track.

11. The method of claim 8, wherein the specific location is determined based on at least one of a quick response (QR) code, an alphanumeric code, GPS, WiFi triangulation, a proximity to a NFC transmitter, and a barcode.

12. The method of claim 8, wherein the venue is a restaurant having individual seat locations as target delivery locations, the method further comprising identifying at least one individual seat as a target delivery location based on the specific location.

13. The method of claim 8, wherein the venue is a restaurant having table locations as target delivery locations, the method further comprising identifying at least one table as a target delivery location based on the specific location.

14. The method of claim 8, wherein a path followed by the robotic delivery unit to the delivery location is over the head of the user at the specific location.

15. A non-transitory computer-readable medium encoded with instructions for delivering objects to a specific location, the instructions executable by a processor, comprising:
based on a request from a client device, determining a specific location for a robotic delivery unit to deliver an item within a venue, the robotic deliver unit coupled to a payload for supporting the item;
generating a command that instructs the robotic delivery unit to deliver the item to the specific location; and
transmitting the command to the robotic delivery unit to cause the robot delivery unit to:
be positioned at a delivery location and thereby carry the item to the delivery location; and
position the payload supporting the item at the specific location, thereby delivering the item.

16. The non-transitory computer-readable medium of claim 15, further comprising:
generating and displaying a graphical-user interface corresponding to the venue, wherein the graphical user-interface includes user selectable components for selecting items available for delivery within the venue; and
receiving a user-selection on the graphical user interface that identifies the item, wherein the item is delivered by the robotic unit according to delivery details associated with the user-selection.

17. The non-transitory computer-readable medium of claim 15, wherein the robot delivery unit travels along a track contained within the venue and the delivery location consists of a specific position along the track.

18. The non-transitory computer-readable medium of claim 15, wherein the specific location is determined based on at least one of a quick response (QR) code, an alphanumeric code, GPS, WiFi triangulation, a proximity to a NFC transmitter, and a barcode.

19. The non-transitory computer-readable medium of claim 15, wherein the venue is a restaurant having individual seat locations as target delivery locations, the method further comprising identifying at least one individual seat as a target delivery location based on the specific location.

20. The non-transitory computer-readable medium of claim 15, wherein the venue is a restaurant having table locations as target delivery locations, the method further comprising identifying at least one table as a target delivery location based on the specific location.
